(19) United States
(12) Patent Application Publication
(10) Pub. No.: US 2009/0254659 A1
(43) Pub. Date: Oct. 8, 2009

(54) Delayed Downloading Video Service Using Peer-to-Peer (P2P) Content Distribution Network

(76) Inventors: Jun Li, Plainsboro, NJ (US); Snigdha Verma, Somerset, NJ (US); Kumar Ramaswamy, Princeton, NJ (US)

Correspondence Address: Thomson Licensing LLC, P.O. Box 5312, Two Independence Way, PRINCETON, NJ, 08543-5312, US

(21) Appl. No.: 12/225,554

(22) PCT Filed: Apr. 12, 2006
(86) PCT No.: PCT/US2006/013957

§ 371 Date: Sep. 23, 2008

(51) Int. Cl. G06F 15/173; H04N 7/173; G06F 15/16

(52) U.S. Cl. 709/225; 709/226; 709/204

(57) ABSTRACT

A system and method for downloading content in a peer-to-peer network are described including receiving, by a first peer, a list of content available in the peer-to-peer network, requesting, by the first peer, content availability information for a unit of content and receiving, by the first peer, content availability information. A system and method for downloading content in a peer-to-peer network are also described including forwarding, content availability information in response to a request for the content availability information, wherein the content availability information includes a location of a unit of content and a status of each peer in the peer-to-peer network having the unit of content available and receiving a reservation to schedule a download of the unit of content. The system and method also include the ability to allow delayed downloading of the in accordance with a reservation for said content.

### FIELD OF THE INVENTION

The present invention relates to networking and in particular to the distribution of video services over a peer-to-peer content distribution network.

### BACKGROUND OF THE INVENTION

In recent years, Peer-to-Peer (P2P) content distribution has had a significant impact on the media and entertainment industry because of its simplicity and low cost of deployment and operation.

The idea behind P2P content distribution is to utilize the customers' computers as peers to form a network, so that the content can be stored and distributed using customer resources. The service provider only coordinates the content distribution with a lower investment and maintenance cost.

Conventional P2P content distribution can support streaming or instant downloading services, such as file sharing or music streaming/downloading. The present invention addresses the particular problems and solutions of a delayed distribution system using a P2P CDN.

### SUMMARY OF THE INVENTION

For large size content, such as movie files, delayed downloading may be accomplished using a peer-to-peer content distribution network (CDN). The present invention describes how to use a P2P content distribution network for such a delayed downloading service. A mechanism is provided to extend the directory service in a P2P CDN to provide future information regarding content and peer status for delayed downloading, so that the off-peak hours of the network and computer resources can be utilized to improve the delivery efficiency over the infrastructure.

Conventional P2P CDN solutions are used for music and/or small data file downloading, which requires little bandwidth compared to downloading a video file. A standard definition (SD) DVD file is greater than 4 GB and the real-time burst streaming rate for such a file can be as high as 11 Mbps. It is very slow to download or stream video files. Even if the downlink capacity is high enough, the speed will be restricted by the uplink capacity, which is usually much less than the downlink capacity. Delayed distribution is a viable alternative when dealing with large SD or HD video content in the current infrastructure.

A conventional P2P CDN is a network formed by the peer computers. As shown in FIG. 1, the edges of the CDN are pushed all the way to the customers' computers, then both content hosting and distribution is provided using the resources of peers. A conventional P2P CDN thus works in the following way:

1. Among the peer computers, at least one peer needs to run a directory service that collects content availability and accessibility information from the peer computers.

2. A peer queries the directory service, which returns messages containing the content availability information.

3. The requesting peer then downloads the requested content by doing a point-to-point download from the peer containing the content.

The directory service in convention a P2P CDN provides information regarding content and peer status so that users/customers (peers) instantly know the availability of content and can make a downloading decision. Instant downloading works well when the content size is small.

In a conventional P2P CDN, if a peer is busy or inactive, the content on this peer is not available to other peers. In an aspect of the present invention, a peer can make the content available to other peers at a future time. In the present invention the directory service of a P2P CDN is extended/enhanced in order to perform the delayed downloading by modifying the protocol used to communicate between peers.

A system and method for downloading content in a peer-to-peer network are described including receiving, by a first peer, a list of content available in the peer-to-peer network, requesting, by the first peer, content availability information for a unit of content and receiving, by the first peer, content availability information. A system and method for downloading content in a peer-to-peer network are also described including forwarding, content availability information in response to a request for the content availability information, wherein the content availability information includes a location of a unit of content and a status of each peer in the peer-to-peer network having the unit of content available and receiving a reservation to schedule a download of the unit of content. The system and method also include the ability to allow delayed downloading of the in accordance with a reservation for said content.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 is a schematic diagram illustrating the data flow in a conventional peer-to-peer content distribution network.

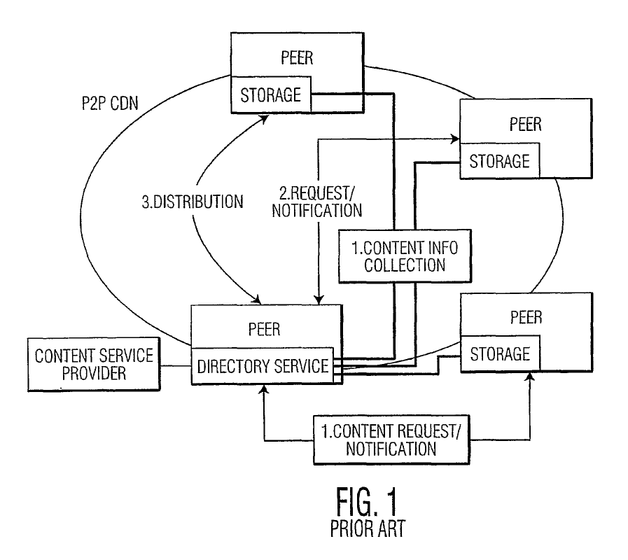

FIG. 2 is a flowchart illustrating the extended protocol message mechanism of the present invention.

FIG. 3 is a flowchart illustrating the delayed directory service mechanism of the present invention.

FIG. 4 is a schematic diagram illustrating the present invention.

### DETAILED DESCRIPTION OF THE PREFERRED EMBODIMENTS

The protocol between the directory service and the peers is best illustrated by the messages sent by the directory service, for example, a peer can obtain a list of content available in the P2P CDN along with the following information regarding the available content (1) the peers hosting the content and (2) current status of the peers, as shown in Table 1. Content may be available on a number of peers. Either the directory service or the peer desiring the content can select the peer to best satisfy the content desired by the requesting peer.

TABLE 1
Content available information in directory service of a P2P CDN

| Content ID | Available at peers | Peer status |
|---|---|---|
| Movie 1 | Peer 2 | Active (Idle) |
| | Peer 4 | Active (Busy) |
| | Peer 6 | Inactive (Power off) |
| Movie 3 | Peer 1 | Active (Serving) |
| | Peer 4 | Active (Busy) |
| | Peer 6 | Inactive (Power off) |

This table shows Movie 1 is available on peers 2, 4 and 6 and Movie 3 is available on peers 1, 4 and 6. Peer 1 is currently serving Movie 3; peer 2 is idle; peer 4 is busy serving other content; and peer 6 is powered off. A peer may request Movie 1 from peer 2, which is currently idle. However, Movie 3 cannot be requested because all peers hosting Movie 3 are either busy or powered off. The protocol between the directory service and the peers is enhanced as described herein so that delayed downloading is supported. That is, a peer can make a request for Movie 3 and have it downloaded at a later time. Delayed downloading can also smooth traffic load by using off-peak hour network resources as well as reduce traffic load by assigning downloading between peers that are proximate to each other.

The directory service is extended by providing future scheduling information in the response to a request for content availability. Future scheduling information; which is generated based on peer requests and peer status includes (1) content's location in the future (see Table 2) and (2) the status of the peers in the future (see Table 3). While illustrated as two separate tables, the location and status tables could be merged as a single table. The peer future status information can be obtained from the peer itself. For example, when a peer joins a P2P community/network, it ca specify the time period that it will remain part of the P2P network. Also, this information can be periodically updated.

TABLE 2
Future content location information in the directory service

| | |
|---|---|
| Movie 1 | Peer 2 (Current) |
| | Peer 1 (1/20/05 3 PM) |
| | Peer 6 (Current - until 1/20/05 10 PM) |
| Movie 2 | Peer 2 (Current) |
| | Peer 3 (Current) |
| | Peer 5 (1/19/05 11 PM) |

TABLE 3
Future peer status information in directory service

| Peer ID | Service schedules |
|---|---|
| Peer 1 | In service (1/20 4-6 PM) (1/20 8-10 PM) |
| Peer 2 | In service (1/20 1-3 PM) |
| Peer 5 | In service |
| Peer 6 | In service |

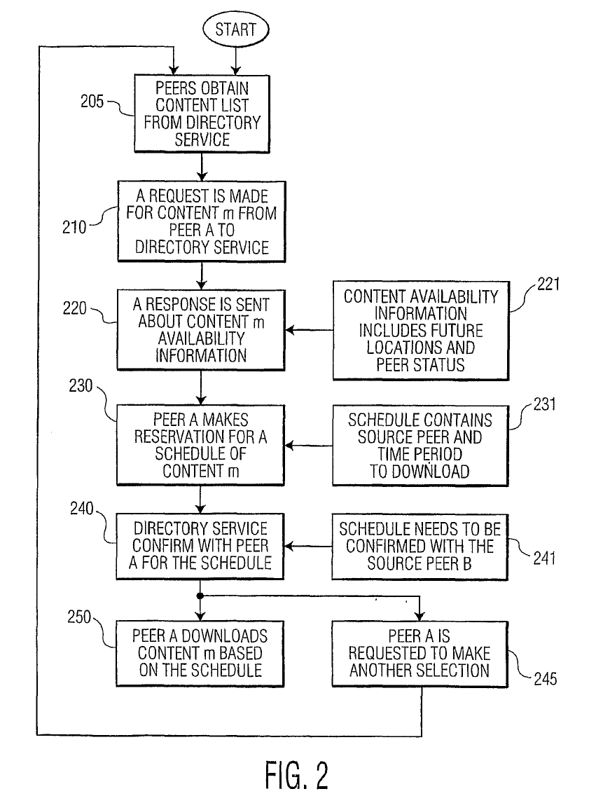

In this manner, delayed downloading service can be supported using the following exemplary steps (see FIG. 2):
1) At step 205, peer A gets a content list from a directory service for available content in a P2P network.
2) At step 210, peer A makes a request (to the directory service) for content m.
3a) The directory service returns (a) m's locations based on the content list (see Table 2) and (b) the status of those peers hosting content m based on the peer status list (see Table 3) at step 221.
3b) At step 220, a response is sent to peer A regarding content m availability.
4) At step 230, peer A makes a reservation with the directory service for the desired schedule to download content m. The delivery schedule includes the source peer (e.g., peer B) and the time period (period T) to download the desired content at step 231.
5) At steps 240 and 241, the directory service returns a confirmed schedule to both peer A and peer B for the time period T=[t₁, t₂].
6) If the directory service rejects the desired schedule, peer A is requested to make another selection at step 245.
7) If the directory service accepts the selected schedule, the peer A downloads the content m based on the schedule at step 250.

This method requires that all peers participating in the P2P CDN honor the schedules confirmed by the directory service. Peers should not only commit to the schedule for their own requests but also commit to serve other peers. This requirement may not be easy to achieve because the conditions of a P2P network can be very unpredictable. For example, peers can always turn off their computers.

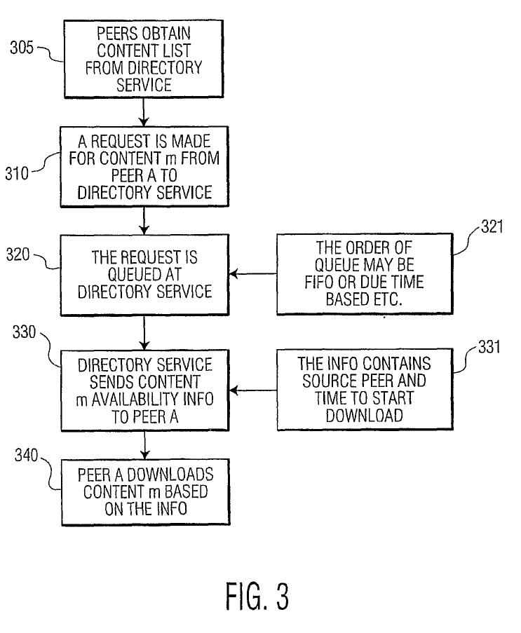

Modifications to the protocol between peers, which support delayed downloading of the requested content until network resources are available, are described now. Not only may the downloading be delayed by the response to the request may also be delayed until the network resources are available. The method is called delayed directory service herein. An exemplary embodiment is shown in FIG. 3 and includes the following steps:
1) At step 205, a peer (peer A) receives a content list from a directory service of a P2P CDN of content in the P2P CDN.
2) At step 310, peer A makes a request to the directory service for content m and waits for a response from the directory service. This response is processed by, for example, software executing on the peer hosting the directory service.
3) At step 320, the directory service queues the request made by peer A. Per step 321, the order of the queue may be first-in-first-out or due-time based or some other scheme.
4) At steps 330 and 331, the directory service sends peer A the requested content availability information including which peer can deliver content m and when (what time period) there will be a peer (e.g., peer B) that can serve peer A's request for content m.
5) At step 340, peer A will then download content in according to the schedule of the delayed directory service.

The directory service determines when to send a message to peer A to update content availability information for content m. Since the requests are queued in a preferred order, the directory service controls the downloading order for peers' requests. For example, the directory service can choose to let peer B serve peer C earlier than peer A by sending the directory update message first to peer C. This may be done, for example, because the request made by peer C is earlier than the request made by peer A.

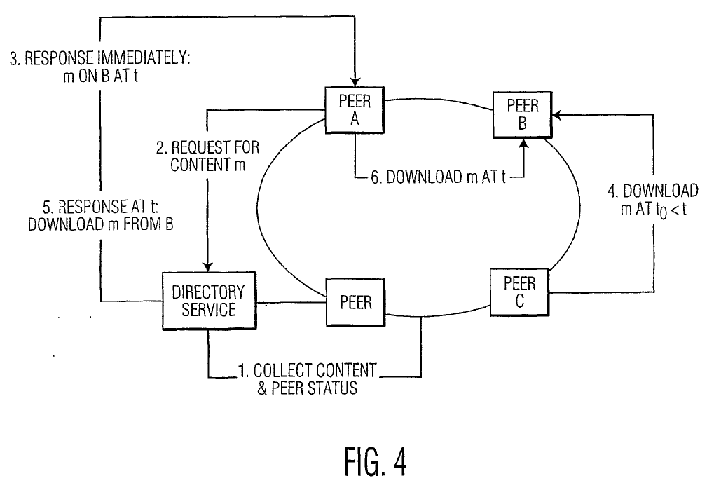

Referring now to FIG. 4, the directory service (hosted on at least one peer) has the status of each peer, the location of current content and future availability (of content and the peers). The directory service collects content and peer status information continually (see data flow line 1 on FIG. 4). When peer A requests content m from the directory service (see data flow line 2 on FIG. 4), the directory service can respond immediately with downloading instructions for peer A to download from a peer that has or will have content m at some future time period. Two cases are illustrated in FIG. 4. In the first case, the directory service responds to peer A to download content m from peer B at time t (see data flow line 3 on FIG. 4). In the second case, peer B may not have content m at the current time. Peer C may have the content at the current time. However, peer C may be currently unavailable or otherwise busy etc. The directory service, therefore, instructs peer C to download content m to peer B at time to <t ((see data flow line 4 on FIG. 4). Instead of responding immediately to peer A (see data flow line 3 on FIG. 4), in this second case, the directory service waits until the network resources are available and at time t instructs peer A to download content m from peer B (see data flow line 5 on FIG. 4). Peer A, in either case, requests content m from peer B at time t (see data flow line 6 on FIG. 4) based on instructions/directions from the directory service.

Both methods can be used with content striping as each segment of content is considered independent, smaller size content. Content striping is where the content is divided up into smaller units and each unit is available on some set of peers. The requesting peer is notified of the total number of units of content for the requested movie and the directory service can schedule the individual units of content to be delivered from a plurality of peers. This is more complex because the requesting peer has to reserve space for the plurality of units and put them in order as they are received but this means that the content may be received faster as the units are transmitted and received in parallel rather than serially.

The enhancements for P2P CDN can also be used in a personal network storage (PNS) based P2P CDN, where the network storage resource is more reliable and the enhancements described herein can be applied effectively.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for downloading content in a peer-to-peer network, said method comprising:
receiving, by a first peer, a list of content available in said peer-to-peer network;
requesting, by said first peer, content availability information for a unit of content;
receiving, by said first peer, content availability information; and
making a reservation to schedule downloading said unit of content, wherein said schedule includes a second peer and a predetermined time period when said second peer is available to support said downloading of said unit of content.

2. (canceled)

3. The method according to claim 1, further comprising:
receiving, by said first peer, a confirmation of said reservation; and
downloading said unit of content.

4. The method according to claim 1, further comprising receiving a rejection of said reservation.

5. The method according to claim 1, wherein said content availability information includes a location of said unit of content and a status of each peer in said peer-to-peer network having said unit of content available.

6. (canceled)

7. The method according to claim 1, wherein said peer-to-peer network is wireless.

8. The method according to claim 1, wherein said peer-to-peer network is a content distribution network.

9. The method according to claim 1, further comprising delayed downloading of said unit of content.

10. A system for downloading content in a peer-to-peer network, comprising:
means for receiving, by a first peer, a list of content available in said peer-to-peer network;
means for requesting, by said first peer, content availability information for a unit of content;
means for receiving, by said first peer, content availability information; and
means for making a reservation to schedule downloading said unit of content, wherein said schedule includes a second peer and a predetermined time period when said second peer is available to support said downloading of said unit of content.

11. (canceled)

12. The system according to claim 10, further comprising:
means for receiving, by said first peer, a confirmation of said reservation; and
means for downloading said unit of content.

13. The system according to claim 10, further comprising means for receiving a rejection of said reservation.

14. The system according to claim 10, wherein said peer-to-peer network is wireless.

15. The system according to claim 10, wherein said peer-to-peer network is a content distribution network.

16. The system according to claim 10, further comprising means for delayed downloading said unit of content.

17. A method for downloading content in a peer-to-peer network, said method comprising:
forwarding, content availability information in response to a request for said content availability information, wherein said content availability information includes a location of a unit of content and a status of each peer in said peer-to-peer network having said unit of content available;
receiving a reservation to schedule a download of said unit of content; and
forwarding a confirmation of said reservation, wherein said reservation is confirmed based on availability of a peer associated with said peer-to-peer network to download said requested content, said peer one of having said requested content presently and having said requested content prior to a predetermined future time necessary to complete said scheduled download.

18. (canceled)

19. The method according to claim 17, wherein said peer-to-peer network is wireless.

20. The method according to claim 17, wherein said peer-to-peer network is a content distribution network.

21. The method according to claim 17, further comprising delayed downloading of said unit of content.

22. A system for downloading content in a peer-to-peer network, comprising:
means for forwarding, content availability information in response to a request for said content availability information, wherein said content availability information includes a location of a unit of content and a status of each peer in said peer-to-peer network having said unit of content available;
means for receiving a reservation to schedule a download of said unit of content; and
means for forwarding a confirmation of said reservation, wherein said reservation is confirmed based on availability of a peer associated with said peer-to-peer network to download said requested content said peer one of having said requested content presently and having said requested content prior to a predetermined future time necessary to complete said scheduled download.

23. (canceled)

24. The system according to claim 22, further comprising means for delayed downloading of said unit of content.
